(19) United States
(12) Patent Application Publication
(10) Pub. No.: US 2006/0246225 A1
(43) Pub. Date: Nov. 2, 2006

(54) Sample carrier based on a porous film with metal oxide particles, the production and utilization thereof, especially for selective detection of phosphorylated/sulphatized biopolymers

(76) Inventors: Thomas Moritz, Berlin (DE); Michael Linscheid, Berlin (DE)

Correspondence Address: ROTHWELL, FIGG, ERNST & MANBECK, P.C., 1425 K STREET, N.W., SUITE 800, WASHINGTON, DC, 20005, US

(21) Appl. No.: 10/556,485

(22) PCT Filed: May 14, 2004
(86) PCT No.: PCT/EP04/05210

§ 371 Date: Feb. 28, 2006

(30) Foreign Application Priority Data
May 20, 2003 (EP) 10322701.6

(51) Int. Cl. B05D 3/02

(52) U.S. Cl. 427/376.2

(57) ABSTRACT

The present invention relates to a porous film comprising metal oxide particles, to a sample holder using the film, to a method of preparation for the sample holder, to the application of the sample holder as well as to a method of detecting phosphorylated/sulphated biopolymers, specifically peptides/proteins.

The present invention relates to a porous film comprising metal oxide particles, to a sample holder using the film, to a method of preparing the sample holder, to the application of the sample holder as well as to a method of detecting phosphorylated/sulphated biopolymers, specifically peptides/proteins.

Phosphorylation and de-phosphorylation processes on biopolymers, specifically proteins, play an important role in the regulation of cellular functions. They take in influence, inter alia, on growth, on metabolism and on the gene expression or dominance. The recognition of the phosphorylation pattern of metabolism and proteome analysis may contribute to a better understanding of the complex regulatory networks and signal transmission systems in a cell. The complete analysis of the phosphorylation pattern of a biologic sample is a great challenge in biochemistry or bioanalysis because the phosphorylated biopolymers, particularly proteins, are present in very low concentrations, in addition to a great number of other bio molecules. Mass spectrometry is one of the most important analytical methods of characterising biopolymers, in particular proteins and peptides. It is an analytical method for the identification of compounds, for checking them for purity and for the exact determination of the qualitative and quantitative composition of a sample as well as of the mass of a compound. In all forms of mass spectrometry, the formation of ions of the species to be studied is required, which are subsequently subdivided and detected in a detector device. Hence, each mass spectrometer comprises three modules, i.e. an ion source, a device for ion separation as well as a device for ion detection. Depending on the type of ion generation, a distinction is made between electron pulse ionisation mass spectrometry (El), chemical ionisation mass spectrometry (CI), Fast Atom Bombardment mass spectrometry (FAB) and matrix-assisted laser desorption/ionisation mass spectrometry (MALDI). The matrix-assisted laser desorption ionisation method (MALDI), linked up with a mass spectrometer, is the method for high-throughput analysis of biopolymer, particularly protein and peptide, mixtures. Due to the low concentration of phosphorylated/sulphated biopolymers, particularly proteins/peptides, complete signal suppression may occur in such a mixture, which means that the detection of these compounds of often impossible. There is accordingly a demand in this field for a method of detecting phosphorylated/sulphated biopolymers, particularly peptides/proteins, which is highly responsive to these substances and selective. In particular, there is a demand for devices and methods facilitating the performance of matrix-assisted laser desorption ionisation mass spectrometry (MALDI mass spectrometry) and rendering them selective and distinctly more responsive to the aforementioned substances.

The problem of the present invention hence resides in the facilitation of the detection of phosphorylated/sulphated biopolymers, specific ally peptides/proteins, also in complex mixtures. It is the objective of the present invention, in particular, to provide a device and a method facilitating the detection of phosphorylated/sulphated biopolymers, specifically peptides/proteins, by means of MALDI mass spectrometry and enhancing the responsiveness of the detection.

These problems are solved by a sample holder for application in MALDI mass spectrometry, comprising:

a substrate,

a porous film comprising metal oxide particles, which is applied on the substrate.

The metal oxide particles are preferably selected from the group including titanium dioxide, zirconium dioxide, niobium oxide, aluminium titanium oxide, tungsten zirconium oxide, hafnium dioxides, tungsten oxide, tin dioxide, lead oxide, lead dioxide, germanium dioxide and gallium oxide (TiO₂, ZrO₂, NbO, Al₂TiO₅, W₂ZrO₈, TiZrO₄, HfO₂, WO₃, SnO₂, PbO, PbO₂, GeO₂ and Ga₂O₃).

According to a particularly preferred embodiment, the metal oxide particles are particles of titanium dioxide, zirconium dioxide and/or titanium zirconium oxide or of a mixture of the aforementioned compounds.

In one embodiment, the film presents an average pore size of <50 nm, preferably a mean pore size in the range from 1 nm to 25 nm, and most preferably a mean pore size in the range between 1 nm and 10 nm.

The film should preferably have a thickness of 0.1 μm to 10 μm, particularly a thickness in the range from 2 to 4 μm and most preferably a thickness of roughly 3 μm.

According to one embodiment, the substrate consists of glass or coated glass. In one embodiment, the glass is conductive glass or glass with a conductive coating. According to a preferred embodiment, the substrate consists of glass coated with indium tin oxide (ITO).

In one embodiment, the substrate consists of aluminium, aluminium with an aluminium oxide layer, especially anodically oxidised aluminium (electrolytic oxidation).

According to one embodiment, the porous film provided on the substrate comprises additionally:

a MALDI matrix.

In one embodiment, the MALDI matrix comprises a substance selected from the group 2,5-dihydroxy benzoic acid, 3,5-dimethoxy-4-hydroxy cinnamic acid, α-cyano-4-hydroxy cinnamic acid, ferulic acid, 2,4,6-trihydroxy acetophenone.

The term “MALDI matrix” as used herein is to be understood in the sense that it denotes any substance suitable as matrix for performance of MALDI mass spectrometry. Examples of such substances are mentioned hereinbelow.

The term “biopolymers” as used herein is to be understood to denote specifically proteins, peptides, nucleic acids, lipids and lipo-polysaccharides.

In one embodiment, the film provided on the substrate is present only on defined areas specifically envisaged to this end and covers them whilst other areas therebetween are left free of the film.

Such “structuring” may be achieved by means of methods and processes known in this field, for example screen-printing techniques, spin-coating techniques, dip-coating techniques, doctor blade methods, drop-casting techniques, each with or without an appropriate dot matrix mask/dot matrix mask sheet presenting the pattern to be applied and desired for the metal oxide film.

In one embodiment, the sample holder moreover comprises:

One or several samples to be analysed, which are applied on the film and which are each presumed to contain one or several substances of interest, it being preferred that the sample(s) contain(s) substances that are selected from the group including nucleic acids and proteins.

It is most preferred that the proteins are phosphorylated and/or sulphated.

The term “substance of interest” as used herein denotes a substance whose detection is envisaged.

In particular, the term “substance of interest” denotes a phosphorylated and/or sulphated biopolymer.

It should be emphasised here that the precise type and nature of the substrate in the inventive sample holder is not essential as long as the suitability of the substrate to hold the inventive film is ensured. As a consequence, the problems of the present invention are also solved by a porous film, independently of a sample holder, which film comprises metal oxide particles, with the film presenting the aforementioned features in preferred embodiments. In one embodiment, the inventive film is applied on a substrate as specified above.

The problems of the present invention are furthermore solved by the application of an inventive film or sample holder, respectively, for the detection of phosphorylated/sulphated biopolymers, specifically peptides/proteins from peptide/protein mixtures, with the detection being preferably carried out by means of matrix-assisted laser desorption ionisation mass spectrometry (MALDI).

The problems of the present invention are also solved by a method of selective detection of phosphorylated/sulphated biopolymers, specifically peptides/proteins from peptide/protein mixtures, comprising the following steps of operation:
providing a sample holder according to the present invention,
providing a sample which is presumed to contain phosphorylated/sulphated biopolymers, specifically peptides/proteins, alone or in combination with other biopolymers, specifically peptides/proteins, and applying the sample on the sample holder,
performing MALDI mass spectrometry.

Moreover, the problems of the present invention are solved by a method of preparing a sample holder for application in MALDI mass spectrometry, with the sample holder including a substrate and a film applied on the substrate and including metal oxide particles, which method comprises the following steps of operation:
preparing a sol from a metal oxide,
inducing gel formation, for example by restriction and/or thermal treatment,
applying the gel on a substrate,
drying and subsequent tempering at 200-600° C., preferably 300 to 450° C., most preferably at roughly 400° C., for a period of 30 minutes to 180 minutes, preferably 30 minutes to 60 minutes, most preferably for roughly 45 minutes.

The metal oxide is preferably selected from the group including titanium dioxide, zirconium dioxide, niobium oxide, aluminium titanium oxide, tungsten zirconium oxide, titanium zirconium oxide, hafnium dioxide, tungsten oxide, tin dioxide, lead oxide, lead dioxide, germanium dioxide and gallium oxide.

In one embodiment, the film presents a mean pore size of <50 nm, preferably in the range from 1 nm to 25 nm, most preferably in the range between 1 nm and 10 nm.

The problems underlying the present invention are equally solved by a sample holder that can be prepared by a method according to the present invention, it being preferred that the sample holder comprises a porous film of metal oxide particles, with the film presenting a mean pore size of <50 nm, preferably from 1 to 25 nm, most preferably in the range from 1 to 10 nm.

The problems of the present invention are furthermore solved also by an application of a sample holder according to the present invention for the selective detection of phosphorylated/sulphated biopolymers, specifically peptides/proteins, with the detection being preferably performed by means of MALDI mass spectrometry.

The problems underlying the present invention are also solved by a method of preparing a sample for MALDI mass spectrometry, using an inventive sample holder, with the method including the following steps of operation:
providing an inventive sample holder,
applying a sample on the metal oxide film of the sample holder, with the sample being presumed to contain phosphorylated/sulphated biopolymers, specifically proteins,
one or several washings steps for washing the metal oxide film,
applying a phosphate-containing medium on the metal oxide film of the sample holder,
applying a MALDI matrix on the metal oxide film of the sample holder.

It is possible to perform a drying step, as required, after the individual steps. Examples of phosphate-containing media are phosphate-containing buffer solutions such as sodium phosphate, potassium phosphate, ammonium phosphate at an appropriate pH level. According to an alternative to the separate application of a phosphate-containing medium and the application of a MALDI matrix, it is also possible that the MALDI matrix as such comprises phosphate groups. Washing in the washing step/washing steps may be performed by application of or rinsing with water, diluted acids, buffer solutions, etc.

The term “MALDI matrix” as used herein is to be understood to denote any substance suitable as a matrix for performing MALDI mass spectrometry. Examples of this are mentioned in the following.

The invention for which this application is filed relates to a sample holder or to a method of selective and highly responsive detection of phosphorylated/sulphated biopolymers, respectively, specifically peptides/proteins in complex peptide/protein mixtures, by means of MALDI mass spectrometry. The invention permits surprisingly a rapid processing of the samples (roughly 30 minutes), extremely small sample volumes (0.5 μl), a strong selectivity and a high responsiveness, whilst it is suitable for a high sample throughput. The invention involves the preparation of sample holders from meso-porous metal oxide films for the detection of phosphorylated and/or sulphated bio molecules and furnishes protocols for the immobilisation, purification and release of the bio molecules on the sample holder. Not intending to be invariably concentrated on a particular mechanism, the inventors presently start out from the fact that the basis of the method is the selective immobilisation of the phosphorylated/sulphated bio molecules in correspondence with their affinity to the meso-porous film and the subsequent release and analysis in a MALDI mass spectrometer. The film consists of particulate metal oxides in the nano range, particularly titanium dioxide and zirconium dioxide, which are produced by means of a sol/gel process.

The term “pore size” as used herein refers to the interstitial space present between the particles positioned in the complex, indicating their average dimensions. The term “meso-porous” as used herein means that the average pore size is in the range below 50 nm, preferably within the range from 1 to 25 nm, most preferably in the range from 1 to 10 nm. The term “particulate metal oxides in the nano range” denotes metal oxides having a particulate character, with the average particle size ranging from 1 to 30 nm.

MALDI sample holders are distributed by the leading manufacturers of mass spectrometers (Applied Biosystems, Waters/Micromass, BrukerDaltoniks). These sample holders serve, on the one hand, to convey the sample into the mass spectrometer and/or to purify or concentrate the sample. A selective immobilisation of phosphorylated/sulphated bio molecules is not achieved by means of commercially available sample holders. The Cyphergen Company offers Protein Arrays on the basis of metal oxides. Here, the pore size exceeds 100 nm, however, so that it is not meso-porous. Moreover, selectivity in terms of phosphorylated/sulphated biopolymers, specifically peptides/proteins, is not described either.

The Immobilised Metal Affinity Chromatography (IMAC) process is equally common and also commercially available (Sigma/Aldrich, Pierce). In this method, the phosphorylated peptides are selectively linked by means of iron cations or gallium cations and are subsequently released again. The disadvantage of this process resides in the aspect that rather substantial sample volumes are required and that immobilisation takes place “off line”, i.e. by means of a separate column/cartridge and that the sample is subsequently applied on a MALDI sample holder. With this approach, it is possible that some sample material is lost and that the responsiveness is reduced.

Moreover, studies have become known from the group around Suzuki et al. (“2D-LC for Selective Extraction of Phosphopeptides using Titania Precolumn“; Poster Abstract, 31^{st} ASMS Conference, Jan. 8-12, 2003, Montreal, Canada), in which the use of titanium dioxide is described as new packing material for the HPLC analysis for the selective purification of phosphorylated compounds. Moreover, the use of a pre-purifying step by means of titanium dioxide HPLC in a column specifically provided to this end is described, with the subsequent analysis by means of mass spectrometry of this pre-purified sample being proposed. The direct application of titanium dioxide films in the mass spectrometer is not taken into consideration.

Now, reference is made to the drawings in which

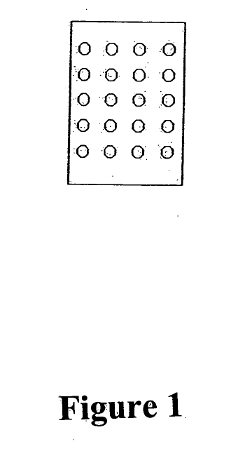

FIG. 1 is an exemplary schematic view of a sample holder made of ITO glass with a metal oxide film applied in islets, with the diameter of the individual “islets” amounting to 1 to 3 mm;

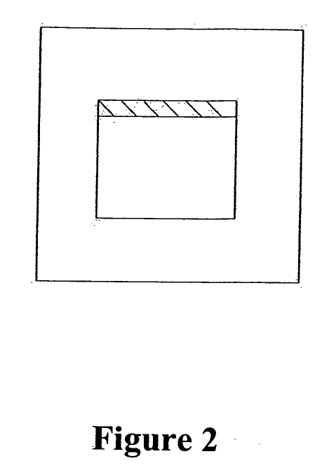

FIG. 2 shows the application of the sample holder according to FIG. 1 in a metal holder of a MALDI mass spectrometer (Voyager DE), with a recess being cut out of the metal holder, which presents the size of the contours of the sample holder.

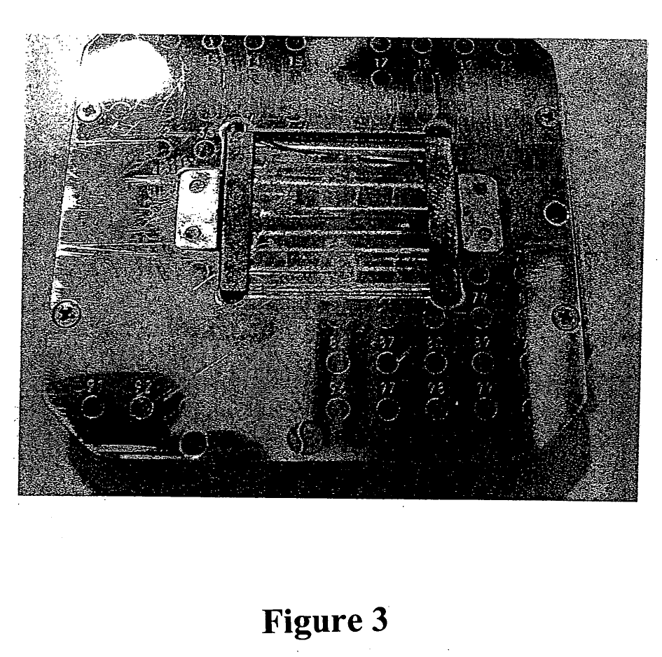

FIG. 3 is a photograph of a holder for an inventive sample holder for application in MALDI time-of-flight mass spectrometry (MALDI-TOF);

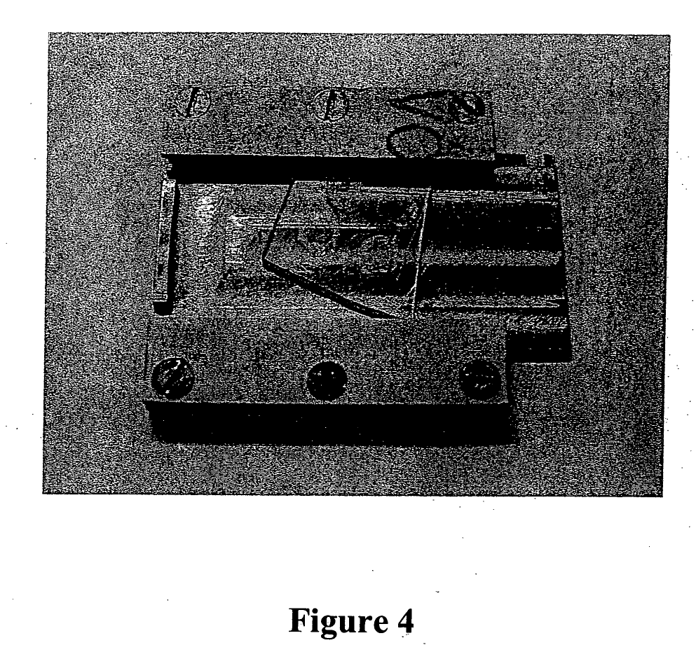

FIG. 4 shows a photograph of another holder for an inventive sample holder for use in MALDI quadrupole ion-trap mass spectrometry under atmospheric pressure (AP/MALDI-QIT);

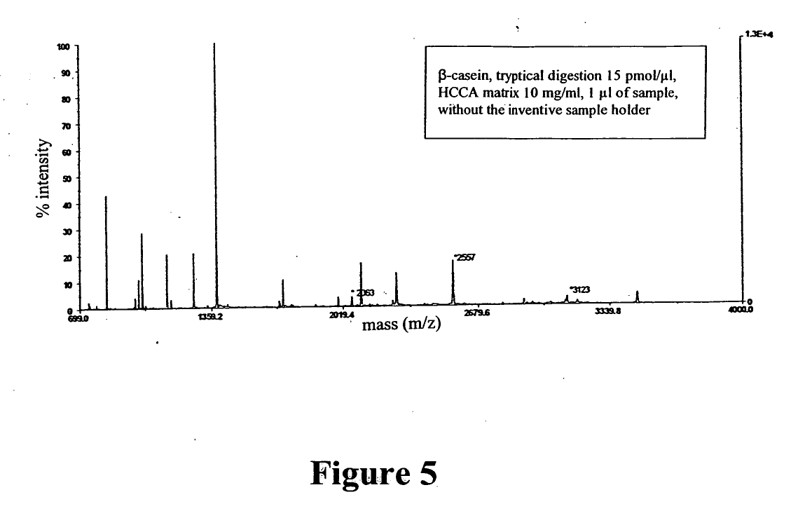

FIG. 5 illustrates the mass spectrum of a tryptical digestion of beta casein without application of the inventive sample holder, and

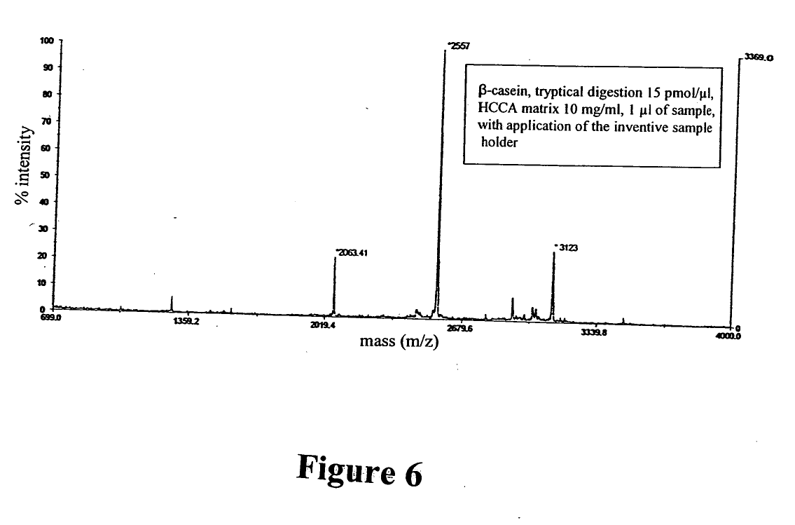

FIG. 6 shows the mass spectrum of a tryptical digestion of beta casein with application of an inventive sample holder.

In the following, the invention will now be explained in more details by the specific examples discussed for explanation only, rather than for a limitation of the invention.

### EXAMPLE 1

Production of one embodiment of a meso-porous metal oxide film

25 ml of titanium tetra-isopropoxide are mixed with 10 ml of isopropanol in a dropping funnel and slowly dripped into 200 ml of water while being stirred. Subsequently, 5 ml to 100 ml of concentrated nitric acid are added (other organic acids may, however, be equally used, such as acetic acid, formic acid, etc.) and cooked for 6 hours with refluxing. The isopropanol so formed is withdrawn. The resulting sol is then processed in an autoclave at 180 degrees Celsius or 18 hours. The resulting sol is then reduced to 15% w/w titanium oxide in a rotary evaporated at 40° C. and 30 mbar, mixed with 20% Carbowax and stirred for 24 hours. The viscous solution is spread on a substrate, e.g. made of glass coated with indium tin oxide (ITO). The substrate was structured by means of an adhesive sheet into which holes of 2 mm diameters, for example, had been punched. Substrate structuring may be performed by any method suitable to this end. Such methods are common to those skilled in the art. Exemplary methods that may be employed and result in a sample holder including areas with and areas without a metal oxide film, are as follows: screen-printing process, spin-coating process, dip-coating process, doctor blade method, drop-casting techniques, each with or without an appropriate dot matrix mask/dot matrix mask sheet presenting the pattern to be applied and desired for the metal oxide film.

When the solution has been dried the sheet is removed. Then, the glass substrate is tempered at 400° C. for 45 minutes. In this manner, meso-porous metal oxide films are produced which have a diameter of 2 mm and a thickness of 2 micrometers. After cooling, the ITO glass is cut into pieces having a size of 3×2 cm.

The concentration of the phosphorylated/sulphated proteins/peptides during application of the sample takes place via an inventive metal oxide film. Immediately after the application of the sample, appropriate (different) washing solutions are used for washing, which are applied and removed again after an appropriate period, with the washing solutions serving to aim at two different objectives, without the inventors intending to be bound to a specific mechanism: 1. washing out the non-combined non-phosphorylated proteins/peptides, 2. Loosening up the bonding of the phosphorylated proteins/peptides by the addition of a phosphate-containing buffer, with the phosphates contained in the buffer removing the combined phosphorylated proteins/peptides at least partly out of their bond to the metal oxide film and rendering them thus accessible to the desorption ionisation process. As a matter of fact, it was surprising to find that the application of a phosphate-containing buffer onto the metal oxide film enhances distinctly the responsiveness in the subsequent mass spectrometry operation. Subsequently, a matrix common for the MALDI technique (for instance 2,5-dihydroxy benzoic acid, 3,5-di-methoxy-4-hydroxy cinnamic acid, ferulic acid, 2,4,6-trihydroxy acetophenone, α-cyano-4-hydroxy cinnamic acid (HCCA), is applied. As an alternative of the separate application of a phosphate-containing buffer and a MALDI matrix it is equally possible to apply a phosphate-containing MALDI matrix that acts not only as a matrix but induces also the aforementioned “phosphate exchange”. The introduction of the sample holder so prepared and provided with the sample into the mass spectrometer is carried through, for instance, by means of a modified metal support for the MALDI-TOF Voyager DE device of the Applied Biosystems Company. A recess in the size of the ITO glass was milled into the metal support. The glass is placed into the recess and contacted with metal tongues (cf. FIGS. 1 and 2 for a schematic view and FIGS. 3 and 4 for photographs of sample holders actually produced). FIG. 1 illustrates a glass (1) with ITO coating, on which a metal oxide film is provided in an “islet” arrangement, with the individual spots (islets) 2 of the metal oxide film presenting a mean diameter of 1 to 3 mm.

FIG. 2 is a schematic view of a holder (3) of a MALDI mass spectrometer (or Voyager DE from Applied Biosystems) into which a recess (4) having the size of the glass with ITO coating according to FIG. 1 has been milled. Moreover, FIG. 2 shows a metal tongue (5) for contacting the inventive sample holder (e.g. the glass with ITO coating from FIG. 1). FIGS. 3 and 4 illustrate a holder for an inventive sample holder, which has been prepared and actually employed in practical operation; FIG. 3 shows a holder used in practical operation for MALDI Time-of-flight mass spectrometry (MALDI-TOF) whilst FIG. 4 illustrates a holder used for MALDI quadrupole ion trap mass spectrometry at atmospheric pressure (AP/MALDI-QIT). The metal oxide film applied in the form of islets can be seen in the form of circles on the glass in both figures.

### EXAMPLE 2

For the detection of phosphorylated peptides by means of MALDI mass spectrometry the following technique may be employed, for example:

The concept of this technique is as follows: the sample to be analysed, which is presumed to contain phosphorylated peptides(sulphated peptides, is applied on an inventive MALDI sample holder (with a metal oxide film, which concentrates the phosphorylated peptides/proteins selectively whilst other proteins/peptides, which are not phosphorylated/sulphated, can be removed by means of suitable washing solutions. The result is a sample holder enriched with phosphorylated/sulphated proteins/peptides, which may be subsequently used directly in MALDI mass spectrometry. Different buffers may be used for the washing steps following the application of the sample, depending on the type, volume and origin of the applied sample. Then a matrix common for the MALDI technique is applied, which will be referred to here as “MALDI matrix”.

The following protocol may be employed, for instance, for the successful and highly selective detection of phosphorylated peptides:

Protocol for the detection of phosphorylated peptides

1 μl of the sample solution is pipetted onto a film prepared according to Example 1

Wait for 15 minutes

Remove supernatant solution by means of a pipette

Wash three times with 2 μl of water

Wash three times with 2 μl mM of acetic acid

Pipette 1 μl of 100 mM ammonium dihydrogen phosphate onto the film

Wait for 15 minutes

Pipette MALDI matrix onto the film (for instance: 2,5-dihydroxy benzoic acid, 3,5-dimethoxy-4-hydroxy cinnamic acid, ferulic acid, 2,4,6-trihydroxy acetophenone, α-cyano-4-hydroxy cinnamic acid)

Let it dry and measure by means of a MALDI mass spectrometer.

As an alternative, it is possible to apply a phosphate-containing/phosphate group-containing MALDI matrix onto the film instead of the separate application of a phosphate buffer.

### EXAMPLE 3

FIGS. 5 and 6 illustrate a mass spectrum of a tryptical digestion of beta casein, which is obtained without (FIG. 5) and with (FIG. 4) the use of an inventive sample holder (trypt. digestion 15 pmol/μl, HCCA matrix 10 mg/ml, 1 μl of the sample). The peaks associated with phosphor peptides (phosphorylated peptides) are marked by an asterisk. The respective peaks in FIG. 5 are extremely small and are clearly superimposed by other peaks of non-phosphorylated peptides. By contrast, FIG. 6 shows the three highest peaks as peaks based on phosphorylated peptides. This means that the use of an inventive sample holder results in a highly selective and highly responsive detection of phosphorylated peptides.

As the sample holder is a component of the MALDI spectrometer or of the associated process, respectively, expensive and troublesome preliminary purification steps in separate devices are no longer required and, so to speak, “on-line” immobilisation, purification, concentration and release of phosphorylated/sulphated peptides/proteins takes place, which renders the inventive device or the inventive method, respectively, best suitable for a high-throughput analysis by means of MALDI mass spectrometry.

The features of the invention, which have been disclosed in the foregoing description, in the claims as well as in the drawings, may be essential for the implementation of the invention in its different embodiments, both individually and in any combination whatsoever.

1. Sample holder for application in MALDI mass spectrometry, comprising:
a substrate
a porous film present on the substrate and comprising metal oxide particles.

2. Sample holder according to claim 1, characterised in that the metal oxide particles are selected from the group including titanium dioxide, zirconium dioxide, niobium oxide, aluminium titanium oxide, tungsten zirconium oxide, hafnium dioxides, tungsten oxide, tin dioxide, lead oxide, lead dioxide, germanium dioxide and gallium oxide (TiO₂, ZrO₂, NbO, Al₂TiO₅, W₂ZrO₈, TiZrO₄, HfO₂, WO₃, SnO₂, PbO, PbO₂, GeO₂ and Ga₂O₃).

3. Sample holder according to claim 1, characterised in that the film has a mean pore size of <50 nm.

4. Sample holder according to claim 3, characterised in that the film has a mean pore size in the range from 1 nm to 25 nm.

5. Sample holder according to claim 4, characterised in that the film has a mean pore size in the range from 1 nm to 10 nm.

6. Sample holder according to claim 1, characterised in that the film has a thickness in the range from 0.1 pm to 10 pm.

7. Sample holder according to claim 6, characterised in that the film has a thickness in the range from 2 to 4 pm.

8. Sample holder according to claim 7, characterised in that the film has a thickness of roughly 3 μm.

9. Sample holder according to claim 1, characterised in that the substrate consists of glass or coated glass.

10. Sample holder according to claim 9, characterised in that the glass is a conductive glass or a glass with a conductive coating.

11. Sample holder according to claim 9, characterised in that the substrate consists of glass coated with indium tin oxide (ITO).

12. Sample holder according to claim 1, characterised in that the porous film applied on the substrate moreover comprises.

13. Sample holder according to claim 12, characterised in that the MALDI matrix comprises a substance selected from the group: 2,5-dihydroxy benzoic acid, 3,5-dimethoxy-4-hydroxy cinnamic acid, a-cyano-4-hydroxy cinnamic acid, ferulic acid, 2,4,6-trihydroxy acetophenone.

14. Sample holder according to claim 1, characterised in that the film applied on the substrate is present only at defined areas specifically envisaged to this end, covering same, whereas other ranges therebetween are left free of the film.

15. Sample holder according to claim 1, furthermore comprising: one or several samples to be analysed, which are applied on the film and which is or are presumed to contain one or several substances of interest.

16. Sample holder according to claim 15, characterised in that said one or several sample(s) contain(s) substances selected from the group including nucleic acids and proteins.

17. Sample holder according to claim 16, characterised in that the proteins are phosphorylated and/or sulphated.

18. Method of selective detection of phosphorylated/sulphated biopolymers, specifically peptides/proteins from peptide/protein mixtures, comprising the following steps of operation:
providing a sample holder according to the present invention,
providing a sample which is presumed to contain phosphorylated/sulphated biopolymers, specifically peptides/proteins, alone or in combination with other biopolymers, specifically peptides/proteins, and applying the sample on the sample holder,
performing MALDI mass spectrometry.

19. Method of preparing a sample holder for application in MALDI mass spectrometry, with the sample holder comprising a substrate and a porous film applied on the substrate and including metal oxide particle, which method comprises the following steps of operation:
preparing a sol from a metal oxide,
inducing gel formation, for example by restriction and/or thermal treatment,
applying the gel on a substrate,
drying and subsequent tempering at 200-600° C., preferably 300 to 450° C., most preferably at roughly 400° C., for a period of 30 minutes to 180 minutes, preferably 30 minutes to 60 minutes, most preferably for roughly 45 minutes.

20. Method according to claim 19, characterised in that the metal oxide is selected from the group including titanium dioxide, zirconium dioxide, niobium oxide, aluminium titanium oxide, tungsten zirconium oxide, hafnium dioxides, tungsten oxide, tin dioxide, lead oxide, lead dioxide, germanium dioxide and gallium oxide (TiO₂, ZrO₂, NbO, Al₂TiO₅, W₂ZrO₈, TiZrO₄, HfO₂, WO₃, SnO₂, PbO, PbO₂, GeO₂ and Ga₂O₃).

21. Method according to claim 19, characterised in that the film has a mean pore size of <50 nm.

22. Method according to claim 21, characterised in that the film has a mean pore size in the range from 1 nm to 25 nm.

23. Method according to claim 22, characterised in that the film has a mean pore size in the range from 1 nm to 10 nm.

24. Sample holder suitable for preparation according to a method according to claim 19.

25. Sample holder according to claim 24, comprising a porous film of metal oxide particles, with the film having a mean pore size of <50 nm, preferably in the range from 1 to 25 nm, most preferably in the range from 1 nm to 10 nm.

26. Application of a sample holder according to claim 1 for selective detection of phosphorylated/sulphated biopolymers, specifically peptides/proteins.

27. Application according to claim 26, with detection being performed by means of MALDI mass spectrometry.

28. Method of preparing a sample for MALDI mass spectrometry, using a sample holder according to claim 1, with the method comprising the following steps of operation:
Providing a sample holder according to claim 1,
Applying a sample on the metal oxide film of the sample holder, which is presumed to contain phosphorylated/sulphated biopolymers, specifically peptides/proteins,
Washing the metal oxide film in one or several washing operations,
Applying a phosphate-containing medium onto the metal oxide film of the sample holder,
applying a MALDI matrix onto the metal oxide film of the sample holder.

29. Application of the method according to claim 28 for performing MALDI mass spectrometry.

30. Method of preparing a sample for MALDI mass spectrometry, using a sample holder according to claim 24, with the method comprising the following steps of operation:
Providing a sample holder according to claim 24,
Applying a sample on the metal oxide film of the sample holder, which is presumed to contain phosphorylated/sulphated biopolymers, specifically peptides/proteins,
Washing the metal oxide film in one or several washing operations,
Applying a phosphate-containing medium onto the metal oxide film of the sample holder,
applying a MALDI matrix onto the metal oxide film of the sample holder.
